(19) United States
(12) Patent Application Publication
(10) Pub. No.: US 2016/0306508 A1
(43) Pub. Date: Oct. 20, 2016

(54) USER INTERFACE FOR A TACTICAL BATTLE MANAGEMENT SYSTEM

(71) Applicant: THALES CANADA INC., Toronto (CA)

(72) Inventors: Derek VOISIN, Ottawa (CA); Jean-Francois MOREAU, Ottawa (CA); Darren HUNTER, North Gower (CA); Paul DEGRANDPRE, Lanark Highlands (CA)

(21) Appl. No.: 15/100,391

(22) PCT Filed: Dec. 1, 2014
(86) PCT No.: PCT/CA2014/000859

§ 371 Date: May 31, 2016

Related U.S. Application Data
(60) Provisional application No. 61/910,686, filed on Dec. 2, 2013.

(51) Int. Cl. G06F 3/0482; G06F 3/0488; G06F 3/0484; G06F 3/0481

(52) U.S. Cl. CPC G06F 3/0482; G06F 3/04817; G06F 3/04886; G06F 3/04883; G06F 3/04847

(57) ABSTRACT

A user interface menu for a user interface displayed on a touchscreen device, the user interface menu for executing an application, the user interface menu comprising a menu button displayed at a first given corner of the screen of the touchscreen device and at least one icon displayed surrounding the menu button upon detection of a finger gesture on the menu button, each of the at least one icon for executing a corresponding application upon detection of a given finger gesture on it.

### CROSS-REFERENCE TO RELATED APPLICATIONS

This application claims priority on U.S. application Ser. No. 61/910,686, filed on Dec. 2, 2013, which is incorporated herein by reference.

### FIELD

This application relates to the field of computer user interface. More precisely, this invention pertains to a user interface for a tactical battle management system.

### BACKGROUND

Command and control, as well as battle management system applications, have been deployed in fighting vehicles for the last twenty years for most fighting forces worldwide. Unfortunately, these applications have struggled to gain user acceptance because they have employed typical desktop/office controls, widgets and layouts that are not conducive to the restrictive and harsh operation environment for inland-force vehicles.

Attempts have been made to address the inherent vehicle-based usability issues by adjusting the typical desktop/office controls and layouts, but these applications still have not addressed fundamental flaws.

Another issue is the fact that, in such software, many options are available, and it is key for a user to be able to quickly access these options with minimum effort. Moreover, memorization of controls is also key for these types of applications.

In fact, attempts have used typical rectangular controls and layouts in a big-button fashion to address the interface issues. These solutions have typically been adaptations of desktop applications within a mobile fighting vehicle. These applications do not focus on a space-constrained, rough-use (rough-terrain) mobile vehicle and quick interaction (mini-step user interaction).

It is therefore an object of this invention to overcome at least one of the above-identified drawbacks.

### BRIEF SUMMARY

According to one aspect there is disclosed a user interface menu for a user interface displayed on a touchscreen device, the user interface menu for executing an application, the user interface menu comprising a menu button displayed at a first given corner of the screen of the touchscreen device and at least one icon displayed surrounding the menu button upon detection of a finger gesture on the menu button, each of the at least one icon for executing a corresponding application upon detection of a given finger gesture on it.

According to one embodiment, a plurality of icons is displayed surrounding at least one part of the menu button.

According to one embodiment, the plurality of icons has a shape of an arch surrounding at least one part of the menu button.

According to one embodiment, the plurality of icons comprises a first-level menu comprising a first portion of icons surrounding the center portion and a second-level menu comprising a second portion of the plurality of icons surrounding at least one given icon of the first portion, further wherein the second-level menu is displayed upon detection of a corresponding finger gesture performed on the at least one given icon of the first-level menu.

According to one embodiment, the second-level menu has a shape of an arch surrounding the first-level menu.

According to one embodiment, at least one of the at least one icon displayed surrounding the menu button is a graphical representation indicative of a corresponding application.

According to one embodiment, at least one of the at least one icon displayed surrounding the menu button comprises a text indicative of a corresponding application.

According to one embodiment, the finger gesture comprises a finger touch.

According to one embodiment, the user interface menu further comprises a second menu button displayed at a second given corner different from the first given corner of the screen of the touchscreen device and at least one icon displayed surrounding the second menu button upon detection of a finger gesture on the second menu button, each of the at least one icon for executing a corresponding application upon detection of a given finger gesture on it.

According to one embodiment, the user interface menu further comprises a third menu button displayed at a third given corner different from the first given corner and the second given corner of the screen of the touchscreen device and at least one icon displayed surrounding the third menu button upon detection of a finger gesture on the third menu button, each of the at least one icon for executing a corresponding application upon detection of a given finger gesture on it.

According to one embodiment, the user interface menu further comprises a fourth menu button displayed at a fourth given corner different from the first given corner, the second given corner and the third given corner of the screen of the touchscreen device and at least one icon displayed surrounding the fourth menu button upon detection of a finger gesture on the fourth menu button, each of the at least one icon for executing a corresponding application upon detection of a given finger gesture on it.

According to another aspect, there is disclosed a method for enabling a user to interact with a user interface displayed on a touchscreen device, the method comprising displaying a menu button at a given corner of a touchscreen device; obtaining an input from a user on the menu button; displaying at least one icon surrounding the menu button, each of the at least one icon for executing a corresponding application upon detection of a given finger gesture on it.

According to an embodiment, the input from the user on the menu button comprises a finger touch.

According to an embodiment, the displaying of at least one icon surrounding the menu button comprises displaying a first-level menu comprising a first portion of the at least one icon surrounding the menu button, detecting a finger gesture on a given icon of the first-level menu and displaying at least one icon in a second-level menu comprising a second portion of the at least one icon surrounding at least one part of the given icon.

According to another aspect, there is disclosed a computer comprising a touchscreen device for displaying a user interface to a user; a processor; a memory unit comprising an application for enabling a user to interact with the user interface displayed on the touchscreen device, the application comprising instructions for displaying a menu button at a given corner of a touchscreen device; instructions for obtaining an input from a user on the menu button and instructions for displaying at least one icon surrounding the menu button, each of the at least one icon for executing a corresponding application upon detection of a given finger gesture on it.

According to another aspect, there is disclosed a storage device for storing programming instructions executable by a processor, which when executed will cause the execution by the processor of a method for enabling a user to interact with a user interface displayed on a touchscreen device, the method comprising displaying a menu button at a given corner of a touchscreen device; obtaining an input from a user on the menu button; displaying at least one icon surrounding the menu button, each of the at least one icon for executing a corresponding application upon detection of a given finger gesture on it.

### BRIEF DESCRIPTION OF THE DRAWINGS

In order that the invention may be readily understood, embodiments of the invention are illustrated by way of example in the accompanying drawings.

FIG. 1 is a screenshot that shows an embodiment of a user interface of a tactical battle management system displayed on a touchscreen device. The user interface comprises, inter alia, four (4) corner user interface menus.

FIG. 2 is a screenshot of a user interface of a tactical battle management system showing a corner user interface menu.

FIG. 3 is a screenshot of a user interface of a tactical battle management system showing a corner user interface menu.

FIG. 4 is a screenshot of a user interface of a tactical battle management system showing a window.

FIG. 5A is a screenshot of a user interface of a tactical battle management system showing four (4) corner user interface menus. In this embodiment, a user has interacted with a corner user interface and a first level is displayed.

FIG. 5B is a screenshot of a user interface of a tactical battle management system showing four (4) corner user interface menus. In this embodiment, a user has interacted with a corner user interface and a first-level menu as well as a second-level menu are displayed.

FIG. 6A is a screenshot of a user interface of a tactical battle management system. In this embodiment, a user has interacted with a corner user interface menu causing a first-level menu and a second-level menu to be displayed further wherein a window associated with an application of the second-level menu is displayed.

FIG. 6B is a screenshot of a user interface of a tactical battle management system. In this embodiment, a user has interacted with a corner user interface menu causing a first-level menu and a second-level menu to be displayed further wherein three windows associated with applications of the second-level menu are displayed.

FIG. 7 is a flowchart that shows an embodiment of a method for interacting with the user interface for executing an application on a touchscreen device.

FIG. 8 is a diagram that shows an embodiment of a system in which the user interface for executing an application on a touchscreen device of the tactical battle management system may be implemented.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims, and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details.

Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise. The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise. The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus does not limit the term or phrase it explains. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “respective” and like terms mean “taken individually.” Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is,” and thus limits the term or phrase it explains. For example, in the sentence “the computer sends data (i.e., instructions) over the Internet,” the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to,” the mere usage of the phrase “including but not limited to” does not mean that the term “including” means something other than “including but not limited to.”

Various embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

As disclosed below, the invention may be implemented in numerous ways.

With all this in mind, the present invention is directed to a user interface for executing an application on a touchscreen device.

In one embodiment disclosed herein, the user interface for executing an application is part of a tactical battle management system (TBMS) application. However, it should be understood by the skilled addressee that the user interface for executing an application may be provided in other applications as explained below.

A tactical battle management system is a software-based battle management toolset intended for vehicle-based users who operate at company level or below. The tactical battle management system is intended to enhance the fighting effectiveness of combat vehicles and act as an extension of a weapon system in that vehicle.

More precisely, the tactical battle management system provides a geographic information system centric battle management system with an ability to provide friendly force tracking and basic user communication means (e.g., chat, messages, tactical object exchange).

In fact, the tactical battle management system application is used for enhancing the effectiveness of combat teams by integrating battle map, positional and situational awareness, targeting, fire control, sensor feeds and instant communication tools.

The tactical battle management system application is implemented on a broad range of touchscreen computers in one embodiment.

As further disclosed below, the tactical battle management system application comprises, inter alia, a user interface for executing an application.

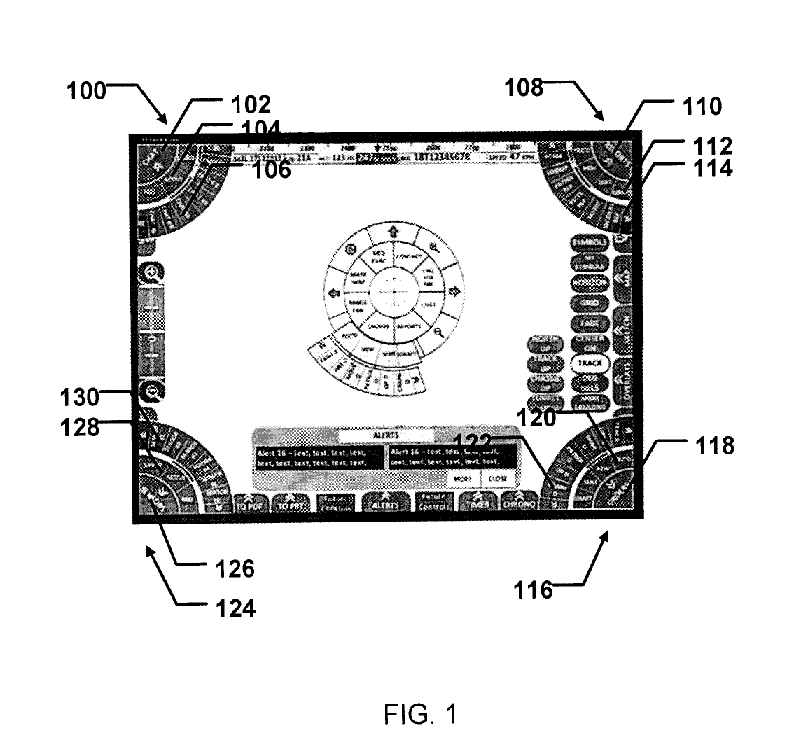

Now referring to FIG. 1, there is shown an embodiment of a user interface of a tactical battle management system.

In this embodiment, the user interface comprises a first corner user interface menu 100, a second corner user interface menu 108, a third corner user interface menu 116 and a fourth corner user interface menu 124.

It will be appreciated that each of the first, second, third and fourth corner user interface menus 100, 108, 116 and 1124 is located at a respective corner of the user interface.

It will be appreciated that having each of the user interface menu at a corresponding corner of the touchscreen display of a portable device is of great advantage since the user can easily interact with the menu using its fingers while holding the portable device.

It will be appreciated that in an alternative embodiment, the corner user interface is located in any one of one, two, three or four corners of the user interface.

More precisely, the first corner user interface menu 100 is located at a top left corner of the touchscreen display, while the second corner user interface menu 108 is located at a top right corner of the touchscreen display, while the third corner user interface menu 116 is located at a bottom right corner of the touchscreen display and while the fourth corner user interface menu 124 is located at a bottom left corner of the touchscreen display.

Still referring to FIG. 1, it will be appreciated that the corner user interface menu 100 comprises a main button 102, a first-level menu 104, and a second-level menu 106. The main button 102 is labeled “Chat.”

Similarly, the second corner user interface menu 108 comprises a main button 110, a first-level menu 112 and a second-level menu 114. The main button 110 is labeled “Reports.”

Similarly, the third corner user interface menu 116 comprises a main button 118, a first-level menu 120 and a second-level menu 122. The main button 118 is labeled “Orders.”

The fourth corner user interface 124 comprises a main button 126, a first-level menu 128 and a second-level menu 130. The main button 126 is labeled “Sensors.”

It will be appreciated that each of the first-level menu and the second-level menu is displayed following an interaction with a user as further explained below.

In one embodiment, the interaction comprises a given finger gesture.

For instance, in the first corner user interface menu 100, the first-level menu 104 is displayed following an interaction of a user with the main button 102.

The second-level menu 106 of the first corner user interface menu 100 is displayed following a detection of a given gesture on the first-level menu 104.

It will be appreciated that, in one embodiment, the second-level menu 106 displayed depends on the nature of the given gesture performed on the first-level menu 104.

In fact, it will be appreciated that the second-level menu 106 may comprise a plurality of icons. The plurality of icons depends on where the user interacted on the first-level menu 104.

The second-level menu 106 can therefore be seen, in one embodiment, as a sub-menu associated with a given icon displayed on the first-level menu 104.

Still referring to FIG. 1, it will be appreciated that each of the first-level menu 104 and the second-level menu 106 comprises at least one icon, each of the at least one icon for executing a corresponding application upon detection of a given finger gesture.

It will be appreciated that, in one embodiment, the first-level menu 104 has a shape of an arch surrounding the main button 102. In one embodiment, the center of the arch is the top left corner.

Similarly, it will be further appreciated that, in one embodiment, the second-level menu 106 has a shape of an arch surrounding the first-level menu 104. In one embodiment, the center of the arch is the top left corner.

It will be further appreciated by the skilled addressee that the at least one icon may be of various types. In one embodiment, an icon is a graphical representation indicative of a corresponding application or function. In an alternative embodiment, an icon comprises a text indicative of the corresponding application.

While in some cases an application may not require a second-level menu, it will be appreciated that in certain cases an application corresponding to an interaction in the first-level menu 104 may require another interaction in the display of the second-level menu 106.

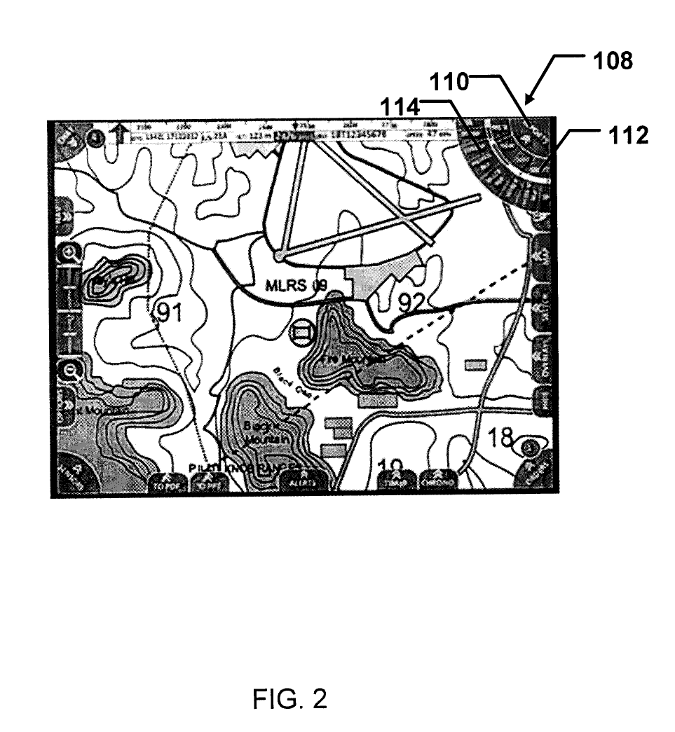

Now referring to FIG. 2, there is shown an embodiment of the second corner user interface menu 108 showing the first-level menu 112 and the second-level menu 114 displayed. It will be appreciated that the corresponding first-level menu and the corresponding second-level menu of each of the first corner user interface 100 of the third corner user interface 116 and of the fourth corner user interface 124 are not displayed.

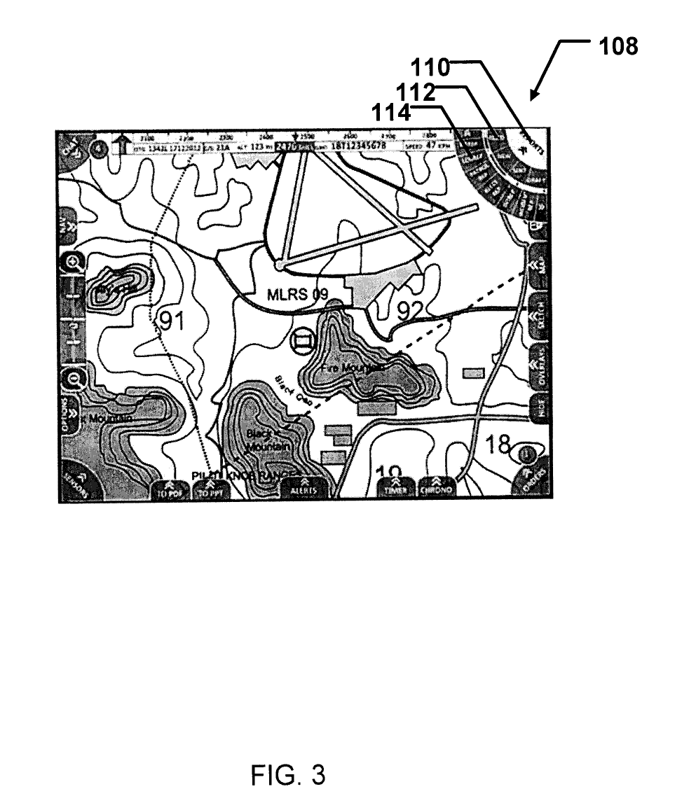

Now referring to FIG. 3, there is shown a further embodiment of the second corner user interface menu 108, disclosing the first-level menu 112 and the second-level menu 114.

It will be appreciated that this specific corner user interface menu 108 is used for providing reports.

Moreover, it will be appreciated that the user may decide to hide the first-level menu 112 and the second-level menu 114 by performing an interaction with the main button 110. The interaction may comprise a finger gesture on the main button 110 such as a single touch of a finger of the user.

Following the finger gesture, the first-level menu 112 and the second-level menu 114 may be hidden.

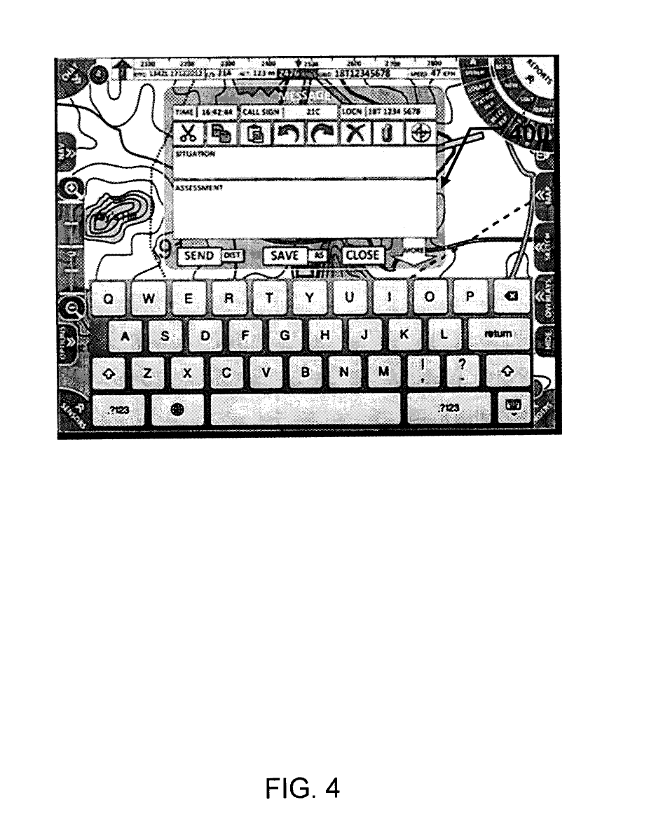

Now referring to FIG. 4, there is shown an embodiment of a window 400 that is displayed on the user interface following an interaction of a user with an icon of the second-level menu 114.

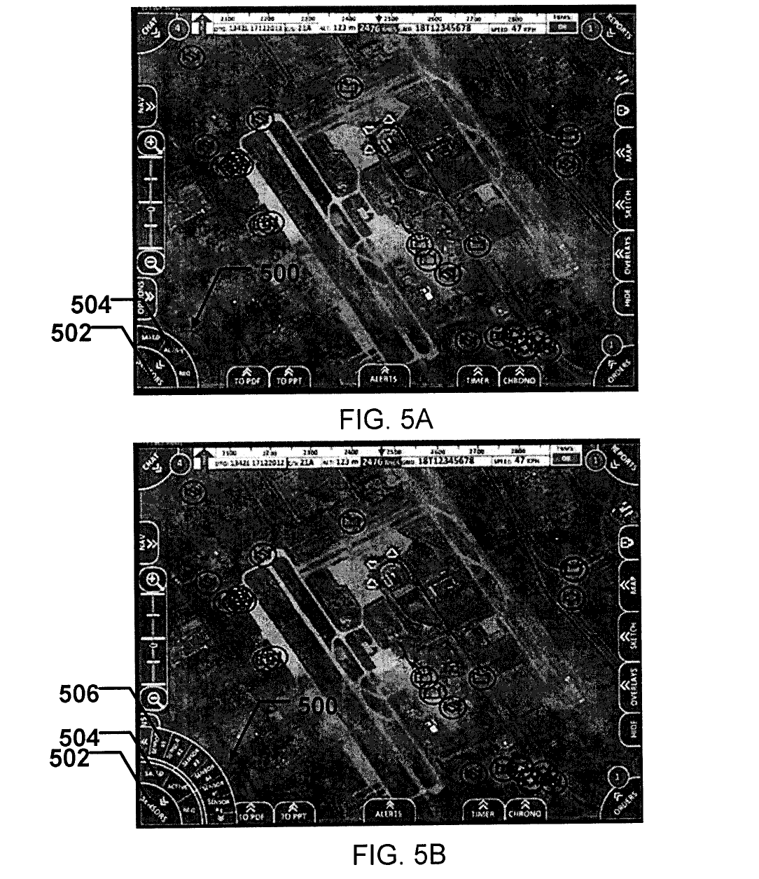

Now referring to FIG. 5A, there is shown a user interface of a tactical battle management system showing a first-level menu 504 displayed in a third corner user interface menu 500.

The first-level menu 504 is displayed following an interaction of the user with the main button 502.

It will be appreciated that the main button 502 is labeled “Sensors.”

Now referring to FIG. 5B, there is shown a user interface of a tactical battle management system wherein a second-level menu 506 is displayed. The second-level menu 506 is displayed following an interaction of the user with the first-level menu 504 associated with the main button 502 of the third corner user interface 500.

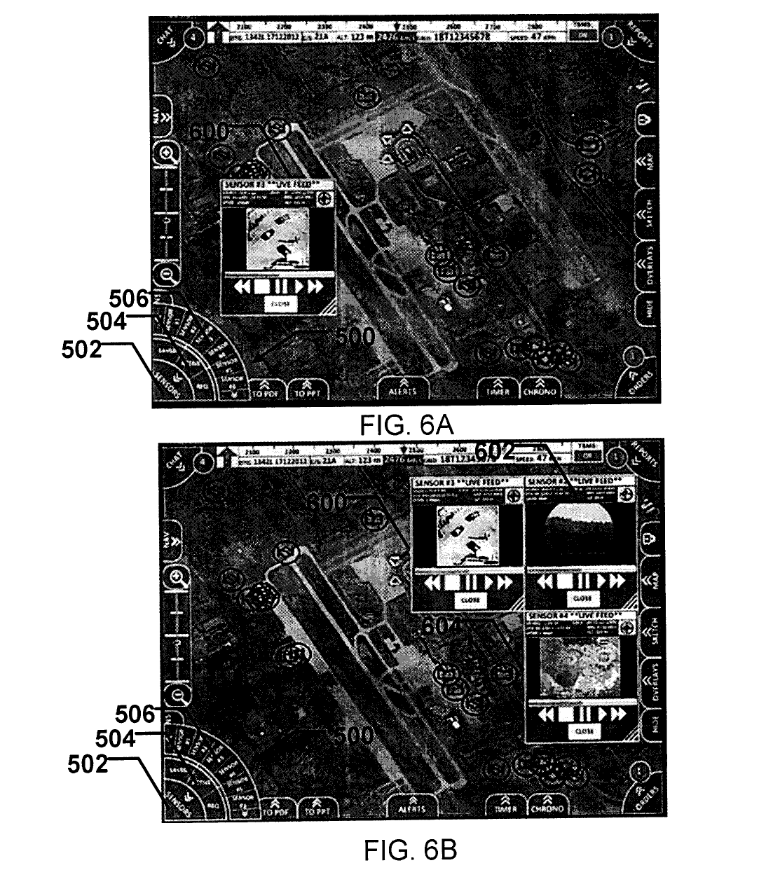

Now referring to FIG. 6A, there is shown a user interface of a tactical battle management system wherein a window 600 is displayed. The window 600 comprises a sensor live feed.

It will be appreciated that this window 600 comprising the sensor live feed is displayed following an interaction of the user with an icon on the second-level menu 506 of the third corner user interface 500.

Now referring to FIG. 6B there is shown another embodiment of a user interface of the tactical battle management system. In this embodiment, the first window 600, a second window 602 and a third window 604 are displayed.

Each of the first window 600, the second window 602 and the third window 604 is associated with a given sensor.

It will be appreciated by the skilled addresses that the first window 600, the second window 602 and the third window 604 are displayed following an actuation of the user with the second-level menu 506 of the third corner user interface menu 500.

It will be appreciated by the skilled addressee that a user may decide to move at least one of the first window 600, the second window 602 and the third window 604 using a given finger gesture in the user interface.

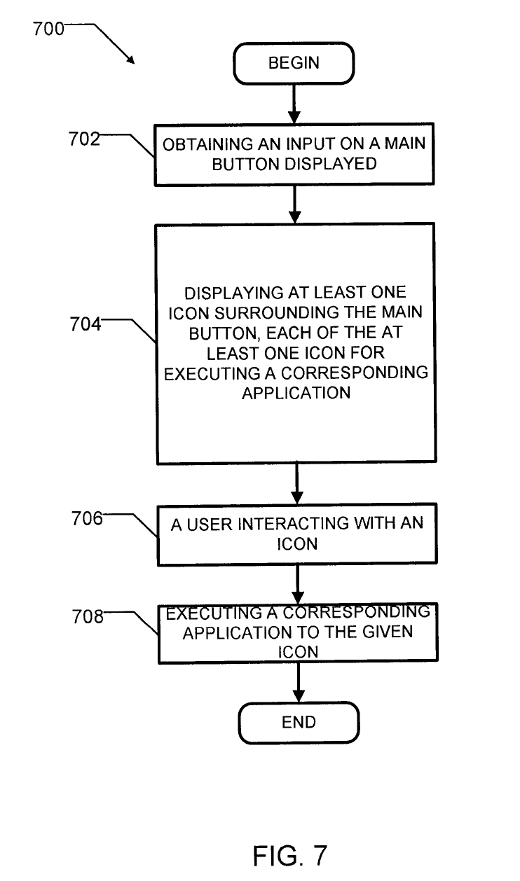

Now referring to FIG. 7, there is shown an embodiment of a method for interacting with the user interface for executing an application on a touchscreen device.

According to processing step 702, an input is obtained on a main button.

It will be appreciated that the main button is displayed in one of the four corners of the touchscreen display.

It will be appreciated that the input may be of various types. In one embodiment, the input comprises a finger gesture performed by a user on the main button, an example of which is a finger touch on the main button displayed.

According to processing step 704, at least one icon surrounding the main button is displayed.

Each of the at least one icon is used for executing a corresponding application. It will be appreciated by the skilled addressee that, in one embodiment, the at least one icon is displayed using multi-level menus.

More precisely, and as illustrated in FIGS. 1 to 6, it will be appreciated that a first-level menu may be displayed following a first interaction of a user with the main button displayed. Following that, the user may further interact to with an icon of the first-level menu causing a second-level menu to be also then displayed. The user may then interact with a given icon of the second-level menu.

According to processing step 706, the user interacts with a given icon 706. It will be appreciated that the user may interact according to various embodiments. In one embodiment, the user interacts using a given finger gesture, an example of which is a click on a corresponding portion of the given icon 706.

According to processing step 708, a corresponding application is executed.

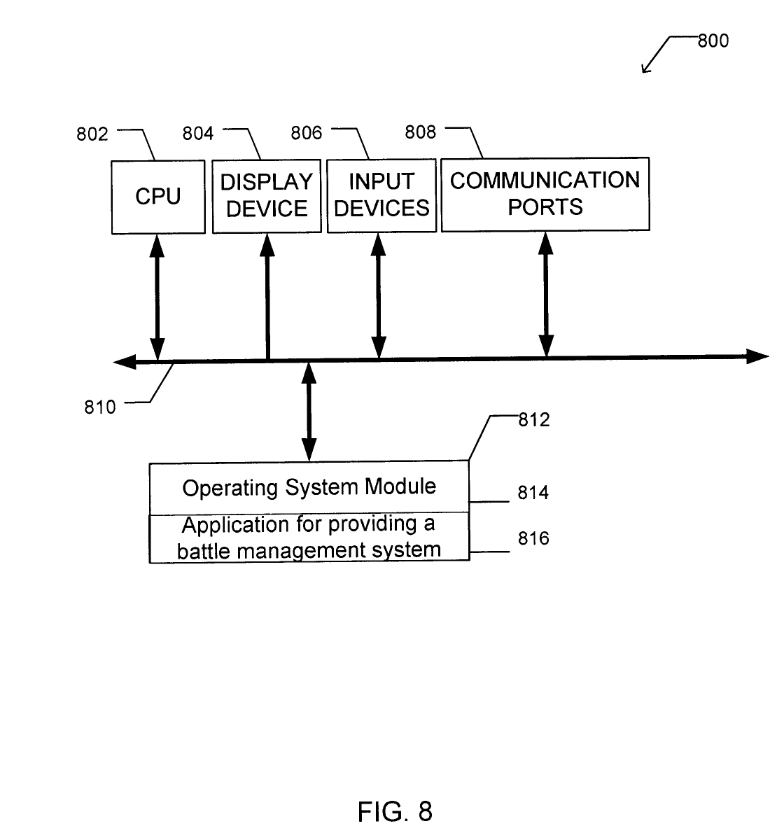

Now referring to FIG. 8, there is shown an embodiment of a system for providing a user interface for executing an application on a touchscreen device.

In this embodiment, the system 800 comprises a CPU 802, a display device 804, an input device 806, a communication port 808, a database 810 and a memory unit 812.

It will be appreciated that each of the CPU 802, the display devices 804, the input devices 806, the communication ports 808, and the memory 812 is operatively interconnected together via the data bus 810.

The CPU 802 may be of various types. In one embodiment, the CPU 1502 has a 64-bit architecture adapted for running Microsoft™ Windows™ applications. Alternatively, the CPU 1502 has a 32-bit architecture adapted for running Microsoft™ Windows™ applications.

The display device 804 is used for displaying data to a user. It will be appreciated that the display 804 may be of various types. In one embodiment, the display device 804 is a touchscreen display device.

The input devices 806 may be of various types and may be used for enabling a user to interact with the system 800.

The communication ports 808 are used for enabling a communication of the system 800 with another processing unit. It will be appreciated that the communication port 808 may be of various types, depending on the type of processing unit to which it is connected and a network connection separating the device 800 and the remote processing unit.

The memory 812 may be of various types. In fact, and in one embodiment, the memory 812 comprises an operating system module 814. The operating system module 814 may be of various types. In one embodiment, the operating system module 814 comprises Microsoft™ Windows 7™ or Windows 8™

The memory unit 812 further comprises an application for providing a battle management system 816. It will be appreciated that the application for providing a battle management system may be of various types.

It will be appreciated that a storage device is further disclosed. The storage device is for storing programming instructions executable by a processor, which when executed will cause the execution by the processor of a method for enabling a user to interact with a user interface displayed on a touchscreen device, the method comprising displaying a menu button at a given corner of a touchscreen device;

obtaining an input from a user on the menu button; displaying at least one icon surrounding the menu button, each of the at least one icon for executing a corresponding application upon detection of a given finger gesture on it.

It will be appreciated that the user interface for executing an application on a touchscreen device disclosed herein is of great advantage for various reasons.

In fact, an advantage of the user interface for executing an application disclosed is that it is readily usable within a high stress and on-the-move environment.

The main button displayed in the corner of the touchscreen display is designed to be sufficiently large to achieve a high success rate even when on-the-move and wearing large winter glove.

Moreover, the user interface for executing an application disclosed is designed to be intuitive such that the user will either understand the operation and functionality intuitively or be able to learn the operation and functionality.

Clause 1. A user interface menu for a user interface displayed on a touchscreen device, the user interface menu for executing an application, the user interface menu comprising:

a menu button displayed at a first given corner of the screen of the touchscreen device,

at least one icon displayed surrounding the menu button upon detection of a finger gesture on the menu button, each of the at least one icon for executing a corresponding application upon detection of a given finger gesture on it.

Clause 2. The user interface menu as claimed in clause 1, wherein a plurality of icons is displayed surrounding at least one part of the menu button.

Clause 3. The user interface menu as claimed in clause 2, wherein the plurality of icons has a shape of an arch surrounding at least one part of the menu button.

Clause 4. The user interface menu as claimed in any one of clauses 2 to 3, wherein the plurality of icons comprises a first-level menu comprising a first portion of icons surrounding the center portion and a second-level menu comprising a second portion of the plurality of icons surrounding at least one given icon of the first portion, further wherein the second-level menu is displayed upon detection of a corresponding finger gesture performed on the at least one given icon of the first-level menu.

Clause 5. The user interface menu as claimed in any one of clauses 1 to 4, wherein the second-level menu has a shape of an arch surrounding the first-level menu.

Clause 6. The user interface menu as claimed in any ones of clauses 1 to 5, wherein at least one of the at least one icon displayed surrounding the menu button is a graphical representation indicative of a corresponding application.

Clause 7. The user interface menu as claimed in any one of clauses 1 to 6, wherein at least one of the at least one icon displayed surrounding the menu button comprises a text indicative of a corresponding application.

Clause 8. The user interface menu as claimed in any one of clauses 1 to 7, wherein the finger gesture comprises a finger touch.

Clause 9. The user interface menu as claimed in any one of clauses 1 to 8, further comprising:

a second menu button displayed at a second given corner different from the first given corner of the screen of the touchscreen device; and

at least one icon displayed surrounding the second menu button upon detection of a finger gesture on the second menu button, each of the at least one icon for executing a corresponding application upon detection of a given finger gesture on it.

Clause 10. The user interface menu as claimed in any one of clauses 1 to 9, further comprising:

a third menu button displayed at a third given corner different from the first given corner and the second given corner of the screen of the touchscreen device; and

at least one icon displayed surrounding the third menu button upon detection of a finger gesture on the third menu button, each of the at least one icon for executing a corresponding application upon detection of a given finger gesture on it.

Clause 11. The user interface menu as claimed in any one of clauses 1 to 10, further comprising:

a fourth menu button displayed at a fourth given corner different from the first given corner, the second given corner and the third given corner of the screen of the touchscreen device; and

at least one icon displayed surrounding the fourth menu button upon detection of a finger gesture on the fourth menu button, each of the at least one icon for executing a corresponding application upon detection of a given finger gesture on it.

Clause 12. A method for enabling a user to interact with a user interface displayed on a touchscreen device, the method comprising:

displaying a menu button at a given corner of a touchscreen device;

obtaining an input from a user on the menu button;

displaying at least one icon surrounding the menu button, each of the at least one icon for executing a corresponding application upon detection of a given finger gesture on it.

Clause 13. The method as claimed in clause 16, wherein the input from the user on the menu button comprises a finger touch.

Clause 14. The method as claimed in any one of clauses 16 to 17, wherein the displaying of at least one icon surrounding the menu button comprises displaying a first-level menu comprising a first portion of the at least one icon surrounding the menu button, detecting a finger gesture on a given icon of the first-level menu and displaying at least one icon in a second-level menu comprising a second portion of the at least one icon surrounding at least one part of the given icon.

Clause 15. A computer comprising:

a touchscreen device for displaying a user interface to a user;

a processor;

a memory unit comprising an application for enabling a user to interact with the user interface displayed on the touchscreen device, the application comprising:

instructions for displaying a menu button at a given corner of a touchscreen device;

instructions for obtaining an input from a user on the menu button;

instructions for displaying at least one icon surrounding the menu button, each of the at least one icon for executing a corresponding application upon detection of a given finger gesture on it.

Clause 16. A storage device for storing programming instructions executable by a processor, which when executed will cause the execution by the processor of a method for enabling a user to interact with a user interface displayed on a touchscreen device, the method comprising displaying a menu button at a given corner of a touchscreen device; obtaining an input from a user on the menu button; displaying at least one icon surrounding the menu button, each of the at least one icon for executing a corresponding application upon detection of a given finger gesture on it.

1. A user interface menu for a user interface displayed on a touchscreen device, the user interface menu for executing an application, the user interface menu comprising:
a first menu button displayed at a first given corner of the screen of the touchscreen device,
at least one icon displayed surrounding the first menu button upon detection of a finger gesture on the first menu button, each of the at least one icon displayed surrounding the first menu button for executing a corresponding application upon detection of a given finger gesture on it;
a second menu button displayed at a second given corner different from the first given corner of the screen of the touchscreen device; and
at least one icon displayed surrounding the second menu button upon detection of a finger gesture on the second menu button, each of the at least one icon displayed surrounding the second menu button for executing a corresponding application upon detection of a given finger gesture on it.

2. The user interface menu as claimed in claim 1, wherein a plurality of icons is displayed surrounding at least one part of the first menu button.

3. The user interface menu as claimed in claim 2, wherein the plurality of icons displayed surrounding the first menu button has a shape of an arch surrounding at least one part of the first menu button.

4. The user interface menu as claimed in claim 2, wherein the plurality of icons displayed surrounding the first menu button comprises a first-level menu comprising a first portion of icons surrounding the center portion and a second-level menu comprising a second portion of the plurality of icons surrounding at least one given icon of the first portion, further wherein the second-level menu is displayed upon detection of a corresponding finger gesture performed on the at least one given icon of the first-level menu.

5. The user interface menu as claimed in claim 1, wherein the second-level menu has a shape of an arch surrounding the first-level menu.

6. The user interface menu as claimed in claim 1, wherein at least one of the at least one icon displayed surrounding the first menu button is a graphical representation indicative of a corresponding application.

7. The user interface menu as claimed in claim 1, wherein at least one of the at least one icon displayed surrounding the first menu button comprises a text indicative of a corresponding application.

8. The user interface menu as claimed in claim 1, wherein the finger gesture comprises a finger touch.

9. The user interface menu as claimed in claim 1, further comprising:
a third menu button displayed at a third given corner different from the first given corner and the second given corner of the screen of the touchscreen device; and
at least one icon displayed surrounding the third menu button upon detection of a finger gesture on the third menu button, each of the at least one icon for executing a corresponding application upon detection of a given finger gesture on it.

10. The user interface menu as claimed in claim 1, further comprising:
a fourth menu button displayed at a fourth given corner different from the first given corner, the second given corner and the third given corner of the screen of the touchscreen device; and
at least one icon displayed surrounding the fourth menu button upon detection of a finger gesture on the fourth menu button, each of the at least one icon for executing a corresponding application upon detection of a given finger gesture on it.

11. A method for enabling a user to interact with a user interface displayed on a touchscreen device, the method comprising:
displaying a first menu button at a first given corner of a touchscreen device;
displaying a second menu button at a second given corner of the touchscreen device different from the first given corner;
obtaining an input from a user on a selected one of the first menu button and the second menu button;
displaying at least one icon surrounding the selected one of the first menu button and the second menu button, each of the at least one icon for executing a corresponding application upon detection of a given finger gesture on it.

12. The method as claimed in claim 11, wherein the input from the user on the selected one of the first menu button and the second menu button comprises a finger touch.

13. The method as claimed in claim 11, wherein the displaying of at least one icon surrounding the selected one of the first menu button and the second menu button comprises displaying a first-level menu comprising a first portion of the at least one icon surrounding the menu button, detecting a finger gesture on a given icon of the first-level menu and displaying at least one icon in a second-level menu comprising a second portion of the at least one icon surrounding at least one part of the given icon.

14. A computer comprising:
a touchscreen device for displaying a user interface to a user;
a processor;
a memory unit comprising an application for enabling a user to interact with the user interface displayed on the touchscreen device, the application comprising:
instructions for displaying a first menu button at a first given corner of a touchscreen device;
instructions for displaying a second menu button at a second given corner of the touchscreen device different from the first given corner;
instructions for obtaining an input from a user on a selected one of the first menu button and the second menu button;
instructions for displaying at least one icon surrounding selected one of the first menu button and the second menu button, each of the at least one icon for executing a corresponding application upon detection of a given finger gesture on it.

15. A storage device for storing programming instructions executable by a processor, which when executed will cause the execution by the processor of a method for enabling a user to interact with a user interface displayed on a touchscreen device, the method comprising displaying a first menu button at a first given corner of a touchscreen device; displaying a second menu button at a second given corner of the touchscreen device different from the first given corner; obtaining an input from a user on a selected one of the first menu button and the second menu button; displaying at least one icon surrounding the selected one of the first menu button and the second menu button, each of the at least one icon for executing a corresponding application upon detection of a given finger gesture on it.

16. The user interface menu as claimed in claim 3, wherein the plurality of icons displayed surrounding the first menu button comprises a first-level menu comprising a first portion of icons surrounding the center portion and a second-level menu comprising a second portion of the plurality of icons surrounding at least one given icon of the first portion, further wherein the second-level menu is displayed upon detection of a corresponding finger gesture performed on the at least one given icon of the first-level menu.

17. The user interface menu as claimed in claim 2, wherein the second-level menu has a shape of an arch surrounding the first-level menu.

18. The user interface menu as claimed in claim 2, wherein at least one of the at least one icon displayed surrounding the first menu button is a graphical representation indicative of a corresponding application.

19. The user interface menu as claimed in claim 2, wherein at least one of the at least one icon displayed surrounding the first menu button comprises a text indicative of a corresponding application.

20. The user interface menu as claimed in claim 2, wherein the finger gesture comprises a finger touch.
